(19) United States
(12) Patent Application Publication
(10) Pub. No.: US 2003/0006726 A1
(43) Pub. Date: Jan. 9, 2003

(54) Electrical brake system

(76) Inventors: Reinhard Weiberle, Vaihingen/Enz (DE); Bernd Kesch, Hemmingen (DE)

Correspondence Address: KENYON & KENYON, ONE BROADWAY, NEW YORK, NY, 10004, US

(21) Appl. No.: 10/119,464

(22) Filed: Apr. 10, 2002

(30) Foreign Application Priority Data
Apr. 12, 2001 (DE) 10 118 262.7

(51) Int. Cl. H02P 3/00

(52) U.S. Cl. 318/370

(57) ABSTRACT

An electrical brake system for a motor vehicle including control modules for controlling the front axle brakes and the rear axle brakes, in which the control modules for the front axle brakes include fault-tolerant behavior, and in which the control modules for the rear axle brakes do not have any external effect in the event of a fault state in the area of the control module.

### FIELD OF THE INVENTION

The present invention relates to an electrical brake system for vehicles.

### BACKGROUND INFORMATION

An electrical brake system is discussed in German Published Patent Application No. 196 34 567 (U.S. Pat. No. 5,952,799), for example. The brake system includes a control module for determining the driver's braking command and control modules for setting the braking force on the wheels of the vehicle, which are interconnected by at least one communications system. To guarantee at least partial functioning in the event of a single fault in the brake system, the control module for determining the driver's braking command is designed to be fault tolerant and is connected, over separate communications systems, to the control modules for setting the braking force, which control a group of wheel brakes. This is intended to ensure that braking of at least a portion of the wheel brakes will remain possible even in the event of a single fault.

German Published Patent Application No. 198 26 131 discusses a control module for determining the driver's command which makes a driver's command available even in the event of a fault. This procedure is intended to ensure the fail-operational property of the control module and to greatly increase the availability and safety of the brake system.

A general goal of electrical brake systems may be to achieve the highest possible availability and safety of the brake system with the lowest possible number of processors. Although this goal may be achievable with the exemplary embodiments mentioned above, they may not be satisfactory in all regards. German Published Patent Application No. 197 52 543 discusses a wheel brake including actuators using electric motors and an integrated parking brake function.

### SUMMARY OF THE INVENTION

Allocating control modules including fail-operational behavior to the front axle of the vehicle and allocating control modules to the rear axle which stop their function in the event of a fault (fail-silent) may allow a considerable reduction in the complexity of the electrical brake system.

The control module for determining the driver's command may be integrated into a control module which controls the front axle. This may eliminate the control module for determining the driver's command without replacement, which may contribute to a further reduction in complexity. The fail-operational property of this control module, which may be like that of prior systems, for example, is intended to guarantee increased availability and safety of the brake system.

Furthermore, a combination of electrohydraulic and electromechanical brake actuators in a hybrid system may be advantageous. The electrohydraulic brake actuators may permit the use of components that have already been manufactured and that may be considered to be reliable. Furthermore, hydraulic brake actuators may allow the application of very high brake forces on the front axle with a minor loss of efficiency, while electromechanical brake actuators, which may be used on the rear axle, may permit an integrated parking brake function.

The present invention is explained in greater detail below on the basis of the exemplary embodiments of the drawings.

### BRIEF DESCRIPTION OF THE DRAWINGS

FIG. 1 shows a block diagram of an exemplary embodiment of an electrical brake system, in which the control modules allocated to the front axle are arranged so that they continue functioning in the event of a fault (fail-operational), while the control modules allocated to the rear axle wheel brakes are shut down in the event of a fault (fail-silent).

FIG. 2 shows another block diagram of an exemplary embodiment of an electrical brake system, in which the control modules allocated to the front axle are arranged so that they continue functioning in the event of a fault (fail-operational), while the control modules allocated to the rear axle wheel brakes are shut down in the event of a fault (fail-silent).

FIG. 3 shows another block diagram of an exemplary embodiment of an electrical brake system, in which the control modules allocated to the front axle are arranged so that they continue functioning in the event of a fault (fail-operational), while the control modules allocated to the rear axle wheel brakes are shut down in the event of a fault (fail-silent).

FIG. 4 shows another block diagram of an exemplary embodiment of an electrical brake system, in which the control modules allocated to the front axle are arranged so that they continue functioning in the event of a fault (fail-operational), while the control modules allocated to the rear axle wheel brakes are shut down in the event of a fault (fail-silent).

FIG. 5 shows another block diagram of an exemplary embodiment of an electrical brake system, in which the control modules allocated to the front axle are arranged so that they continue functioning in the event of a fault (fail-operational), while the control modules allocated to the rear axle wheel brakes are shut down in the event of a fault (fail-silent).

FIG. 6 shows another block diagram of an exemplary embodiment of an electrical brake system, in which the control modules allocated to the front axle are arranged so that they continue functioning in the event of a fault (fail-operational), while the control modules allocated to the rear axle wheel brakes are shut down in the event of a fault (fail-silent).

### DETAILED DESCRIPTION

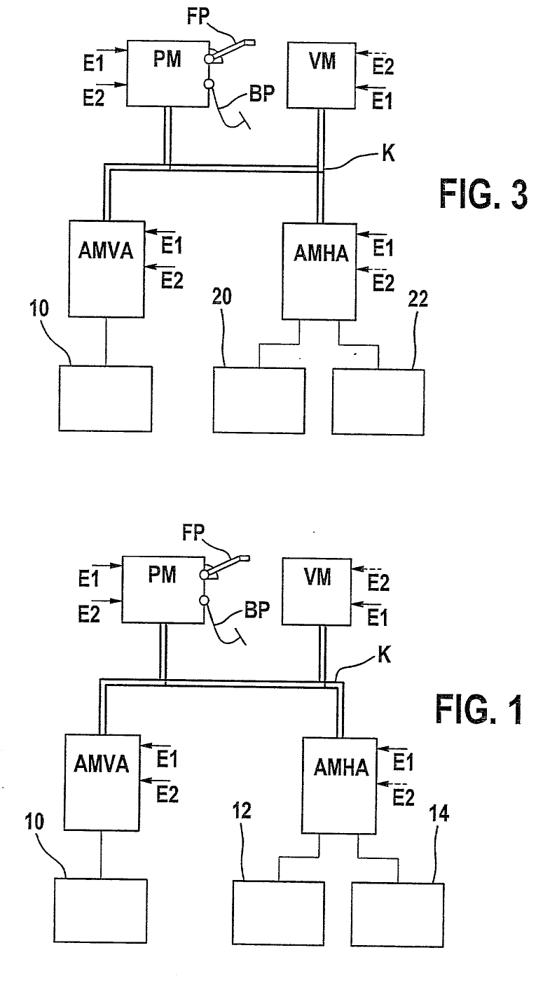

FIG. 1 shows an electrical brake system including at least two control modules (AMVA, AMHA) for setting a braking force on the vehicle wheels. These control modules may be connected to another control module (PM) for detecting the driver's braking command via a communications system K. In addition, in an exemplary embodiment, another control module (VM) may be provided in communications system K for the higher-level brake regulator functions, such as an anti-lock brake control system, a traction control system or an electronic stability program including.

In an exemplary embodiment, communications system K may have a deterministic behavior and may include a redundant data bus. Actuating quantities of these operating elements may be sent to pedal module PM from such operating elements as a brake pedal BP and a parking brake lever FP. The at least one microcomputer contained in control module PM converts these operating signals into setpoint quantities for controlling the wheel brakes. These setpoint quantities may be delivered by control module PM to control modules AMVA, AMHA via communications system K. Control module PM may be designed so that it still has full functioning in the event of a single fault.

In an exemplary embodiment, two independent electric power circuits E1 and E2 may be provided in the vehicle. Control module PM receives power from both power circuits. In another exemplary embodiment, only one power circuit may be provided, but it may be supplied with power from two independent power storage devices, so that the power supply to control module PM may be guaranteed in the event of a failure of one power source.

In the exemplary embodiment in FIG. 1, control modules AMVA, AMHA may be grouped by axles. Control module AMVA controls the brake actuators of the front wheel brakes, while control module AMHA controls the actuators on the rear wheel brakes.

These modules each contain at least one microcomputer. In an exemplary embodiment, an electrohydraulic brake actuator may be provided on the front axle, to build up the braking force on the front wheel brakes by a hydraulic medium according to the control signal(s) of axle module AMVA without hydraulic intervention by the driver to influence the wheel brakes. To ensure brake function, axle module AMVA also may have a fail-operational behavior, i.e., it may be fully functional even in the event of a single fault. This may be achieved through an appropriate control arrangement like that of control module PM. Like control module PM, this control module may be supplied with power either from two independent electric power circuits or from one power circuit including two independent electric power storage devices.

The setpoint values for the braking force to be applied to the wheel brakes, determined by the pedal module, optionally modulated individually for each wheel in control module VM, may be made available to control modules AMVA, AMHA, which set the desired braking force as part of a braking force regulating circuit, a braking torque regulating circuit, a pressure regulating circuit, a traction control circuit, etc.

In the exemplary embodiment illustrated in FIG. 1, an electromechanical brake actuator 12, 14 is assigned to the axle module of rear axle AMHA for each wheel brake and is controlled by control module AMHA via the respective control lines. This control may be accomplished within the context of one of the above-mentioned regulating circuits including an integrated parking brake function (see, for example, German Published Patent Application No. 197 52 543). Axle module AMHA may be provided with fail-silent behavior to reduce complexity. Thus, in the event of a fault, it will shut itself down or will at least no longer deliver any signals to the connected actuators and the communications system. For this reason, it may be sufficient for this axle module to be supplied with power from one power circuit. An implementation example of a control module including fail-silent behavior may also be available from prior systems.

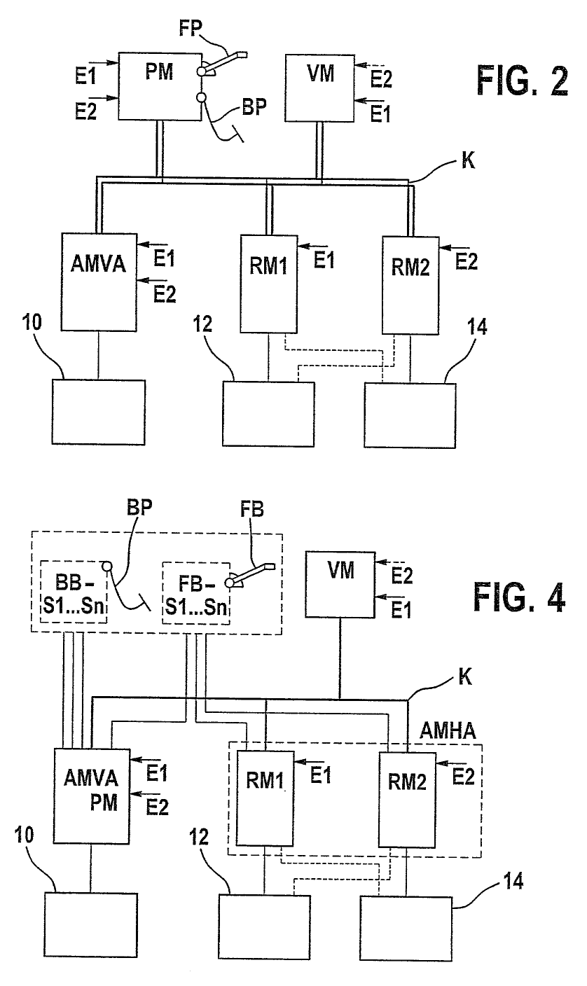

FIG. 2 shows an exemplary embodiment. Here again, an electrohydraulic actuator may be provided for the front axle brakes, and an electromotive actuator may be provided for the rear wheel brakes, control module PM and control module AMVA including fail-operational behavior, as illustrated in the exemplary embodiment in FIG. 1. The difference in comparison with the exemplary embodiment in FIG. 1 is that the axle module of rear axle AMHA is replaced by two wheel modules RM1 and RM2. These wheel modules each include at least one microcomputer, have fail-silent behavior and control an electromechanical brake actuator including an integrated parking brake function as part of one of the regulating circuits mentioned above.

In an exemplary embodiment, the two wheel modules may be supplied with power from two different power circuits to increase availability, for example of the parking brake function, or they may be supplied with power from a secure power circuit including different independent power storage devices, so that in the event of a failure of one power storage device, a parking brake function is still guaranteed on at least one wheel. An example of an integrated parking brake function of an electromechanical brake actuator may be a magnetic holding brake, such as may be available from prior systems; it may have a redundant power supply to guarantee the release of the parking brake even in the event of a fault. The inclusion of this option in the system according to FIG. 2 is indicated by the additional lines leading from the wheel module to the actuator which is allocated to the other wheel module.

FIG. 3 shows an exemplary embodiment in which control module PM, control module AMVA, communications system K, control module VM and actuator 10 correspond to the exemplary embodiment illustrated in FIGS. 1 and 2. There are differences in the area of the rear axle brakes. For example, one axle module AMHA may be provided for the rear axle and may have a fail-silent property. The brake actuator for control of wheel brakes 20 is an electrohydraulic brake actuator without hydraulic intervention by the driver's brake pedal. This brake actuator may be controlled by control module AMHA as part of the above-mentioned control circuits. In addition, at least one electromechanical brake actuator 22 which acts on both wheels of the rear axle may be provided on the rear axle to form a parking brake function. In another exemplary embodiment, two parking brake actuators which act on individual wheels may be provided. The electromechanical brake actuator(s) may be controlled by control module AMHA. Power may be supplied to control module AMHA from two separate electric power circuits or from one power circuit including two independent power storage devices, so that, as explained on the basis of FIG. 1, at least the release of the parking brake is guaranteed even in the event of failure of one power supply.

FIG. 4 shows another exemplary embodiment that includes at least two control modules which set the braking force on the vehicle wheels. One of these control modules, in particular, that belonging to the front axle, may be designed to be fault tolerant and includes the function of a control module for determining the driver's braking command. Determination of the driver's braking command is based on signals from at least three sensors for detecting the driver's operating braking command. Procedures for determining the driver's braking command may be available from prior systems. Likewise, an example of the design of a fault-tolerant control module may also be available from prior systems. In general, such a control module may have at least two microprocessors that may be supplied with electric power from two independent electric power circuits or one power circuit including two independent power storage devices and another hardware unit for monitoring the two microprocessors.

In the exemplary embodiment illustrated in FIG. 4, fault-tolerant control module AMVAPM may be responsible for controlling at least one electrohydraulic brake actuator 10 for the front axle. As an alternative to this, instead of the one electrohydraulic brake actuator, two electromechanical brake actuators may be provided for each wheel brake. Thus the availability of the wheel brakes on the front axle may be further increased, as well as the safety of the entire brake system.

A control module AMHA may be provided for the wheel brakes of the rear axle and includes a control module RM1 and RM2 for each individual wheel. The wheel modules may be supplied with power from different power circuits E1 and E2. They have fail-silent behavior. These control modules may be linked by communications system K and may be connected to another control module VM, which may be optionally provided for the higher-level brake regulating function. The reference input variables or driver's braking command quantities may be sent from control module AMVAPM to the axle module or to the wheel modules for the rear axle brakes via communications system K. Furthermore, the operating status signals of the individual control modules and the setpoint and actual quantities for the higher-level brake regulating functions may be exchanged.

For determination of the driver's command, actuation of brake pedal BP may be detected by at least three sensors S1 through SN, and their signals may be relayed via the corresponding lines to control module AMVAPM. This forms the driver's operating braking command from these signals in accordance with procedures known from prior systems, for example. Furthermore, arrangements may be provided for detecting the driver's command for actuation of the parking brake via at least two sensors S1 through SN. For example, the position of a parking brake lever is determined. At least one sensor signal may be entered and analyzed by control module AMVAPM. The resulting setpoint value for the parking braking force may be sent via the communications system to the control module(s) for the rear axle brakes which additionally enter(s) and analyze(s) the signal of another sensor for detecting the parking brake command. A resulting reference input variable for the parking brake may be generated by a suitable selection strategy, e.g., a maximum value selection, from at least two setpoint values. Suitable arrangements, approaches or methods may be available from prior systems. This determination of the control of the parking brake is at least important to the exemplary embodiments of the present invention independently of the arrangement of the control modules.

The control module for the rear axle and the control modules for the rear axle wheel brakes have fail-silent behavior, i.e., in the event of an intrinsic fault, they no longer send any signal outward and they no longer receive any signals or they shut down. In the event of a failure in the communications system or when a parking brake command sensor is faulty, the availability of the parking brake function may be guaranteed by the fact that an actuating signal of the parking brake lever is input by the control modules on the rear axle.

In the exemplary embodiment illustrated in FIG. 4, by analogy with the exemplary embodiments in FIGS. 2 and 1, the braking force on the rear wheel brakes may be applied by the electromechanical brake actuators including an integrated parking brake function. The control module of the rear axle receives power from at least one electric power circuit and has the functions illustrated on the basis of FIGS. 2 and/or 1.

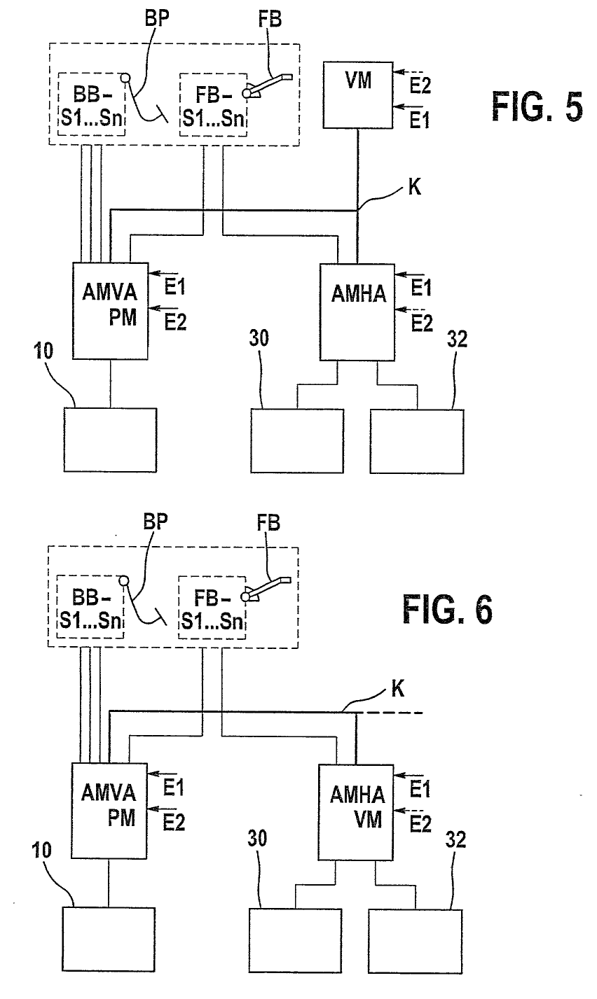

The exemplary embodiments illustrated in FIGS. 5 and 6 differ from the exemplary embodiment of FIG. 4 in that the operating braking force on the rear wheels may be applied by at least one electrohydraulic brake actuator 30. In one exemplary embodiment (FIG. 5), a parking braking force may be applied to the wheels of the rear axle by at least one electromechanical brake actuator 32.

In the exemplary embodiment in FIG. 6, the control module for rear axle AMHA also assumes the role of processing the higher-level brake regulating functions, which may be implemented as a separate control module in the other exemplary embodiments.

In all exemplary embodiments, additional control modules of other control systems such as steering systems, drive control systems, etc., may also be connected to communications systems K, as indicated in FIG. 6.

What is claimed is:

1. An electrical brake system for a motor vehicle, comprising:
at least two control modules to set a braking force at vehicle wheels and which are intercoupled via a communications system;
a first control module of the at least two control modules being allocated to front wheel brakes and being fault tolerant; and
a second control module of the at least two control modules being allocated to rear wheel brakes, and being operable to not achieve any external effect in the event of a fault state.

2. The brake system of claim 1, further comprising:
at least another control module to detect at least one of a driver's operating command and a parking brake command, the at least another control module being fault tolerant and being connected to the communications system.

3. The brake system of claim 1, further comprising:
at least one electrohydraulic brake actuator to build up a braking force on front wheels, while another braking force on rear wheels is built up for at least one of an operating brake and a parking brake via at least one electromechanical actuator.

4. The brake system of claim 3, wherein an operating braking force and a parking braking force of a rear axle are each applied individually for each wheel with one of the at least one electromechanical brake actuator.

5. The brake system of claim 3, wherein two electromechanical brake actuators of a rear axle are controlled by exactly one control module in both an operating brake mode and a parking brake mode.

6. The brake system of claim 3, wherein two electromechanical brake actuators of a rear axle are controlled by two separate control modules that are supplied with electric power from two different independent electric power circuits.

7. The brake system of claim 6, wherein the electromechanical brake actuators of the rear axle are controlled by a control module of the electromechanical actuator for reducing one of the parking braking force and a residual braking force when a fault occurs in one of an allocated control module and its power supply.

8. The brake system of claim 1, wherein an operating braking force of a rear axle is built up by at least one electrohydraulic brake actuator, and a parking braking force is applied by at least one electromechanical brake actuator, both actuators being controlled by a same control module.

9. The brake system of claim 1, wherein a control module for the front wheel brakes is supplied with electric power from one of: at least two independent power circuits, and one power circuit having two independent power storage devices.

10. The brake system of claim 1, further comprising:
another control module to regulate higher-level brake functions, and being coupled to the first control module and the second control module by the communications system.

11. The brake system of claim 10, wherein the communications system has at least one of a redundant characteristic and a deterministic time characteristic.

12. The brake system of claim 1, wherein the first control module for the front wheel brakes includes functions of another control module to determine at least one of an operating brake command and a parking brake command.

13. The brake system of claim 12, wherein the operating braking command is determined based on at least three sensor signals of a brake pedal, the three signals being transmittable to the first control module to control the front wheel brakes.

14. The brake system of claim 1, further comprising:
two electromechanical brake actuators for applying braking forces to front wheels.

15. The brake system of claim 1, wherein processing of higher-level braking regulating functions is performed in at least another control module to set the braking force on rear wheels.

16. The brake system of claim 1, wherein:
a driver's parking brake command is detectable by at least two sensors,
a signal of at least one parking brake sensor is transmittable to each of the control modules to adjust the braking force and to analyze the signal, and
a control module, when not controlling a parking brake actuator, operable to provide a determined parking brake setpoint value to another control module via the communications system.

17. The brake system of claim 1, wherein a control module for setting a parking braking force is operable to generate a resulting reference input variable for a parking brake from a self-analyzed parking brake command signal and a parking brake command signal received via the communications system as a function of an operating state of the vehicle.
